(19) United States
(12) Patent Application Publication
(10) Pub. No.: US 2014/0185192 A1
(43) Pub. Date: Jul. 3, 2014

(54) SOLID ELECTROLYTIC CAPACITOR

(71) Applicant: NEC TOKIN Corporation, Sendai-shi (JP)

(72) Inventors: Yasuhisa SUGAWARA, Sendai-shi (JP); Koji Sakata, Sendai-shi (JP); Yasuhiro Tomioka, Sendai-shi (JP); Hiroyuki Demizu, Sendai-shi (JP); Hiroki Satoh, Sendai-shi (JP)

(73) Assignee: NEC TOKIN Corporation, Sendai-shi (JP)

(21) Appl. No.: 14/109,581

(22) Filed: Dec. 17, 2013

(30) Foreign Application Priority Data
Dec. 27, 2012 (JP) 2012-285518

(51) Int. Cl. H01G 9/004; H01G 9/00

(52) U.S. Cl. CPC H01G 9/004; H01G 9/0036
USPC 361/523; 156/47

(57) ABSTRACT

Provided is a solid electrolytic capacitor having a low initial ESR in which the ESR increase with time can be suppressed. It is a solid electrolytic capacitor, including an electroconductive polymer layer, a graphite layer on the electroconductive polymer layer, and a silver layer on the graphite layer, wherein the electroconductive polymer layer and the graphite layer, and/or, the graphite layer and the silver layer are bonded by a chemical bond.

### TECHNICAL FIELD

The present invention relates to a solid electrolytic capacitor and a method for producing the same.

### BACKGROUND ART

In late years, with downsizing, speeding up, digitization of electronic equipment, capacitors which have a small size, a large capacity, and a low equivalent series resistance (hereinafter, ESR) in a high frequency domain are required also in the field of solid electrolytic capacitor.

As a capacitor which has a small size, a large capacity, and a low ESR in a high frequency domain, an aluminum or tantalum solid electrolytic capacitor using an electroconductive polymer such as a polypyrrole or a polythiophene having a high electroconductivity for the electrolyte is known. This capacitor has a low ESR in comparison with an electrolyte liquid type or manganese dioxide type capacitor because a material having a low resistance is used.

Patent document 1 discloses a solid electrolytic capacitor obtained by forming an oxide film on an anode body valve metal and by forming an electroconductive polymer layer, a graphite layer, and a silver layer on the oxide film.

### PRIOR ART DOCUMENT

### Patent Document

Patent document 1: JP 2010-245313 A

### SUMMARY OF THE INVENTION

### Problem to be Solved by the Invention

However, in the solid electrolytic capacitor shown in Patent document 1, the adhesion property between the electroconductive polymer layer and the graphite layer, and/or, the adhesion property between graphite layer and silver layer is low and a delamination easily occurs by heat or stress. Thus, there is a problem that the solid electrolytic capacitor has a high initial equivalent series resistance (hereinafter, ESR), and that the ESR is increased with time.

The object of the present invention is to provide a solid electrolytic capacitor having a low initial ESR in which the ESR increase with time can be suppressed.

### Means of Solving the Problem

The solid electrolytic capacitor according to the present invention is a solid electrolytic capacitor, including an electroconductive polymer layer, a graphite layer on the electroconductive polymer layer, and a silver layer on the graphite layer, wherein the electroconductive polymer layer and the graphite layer, and/or, the graphite layer and the silver layer are bonded by a chemical bond.

The method for producing a solid electrolytic capacitor according to the present invention is a method for producing a solid electrolytic capacitor which includes an electroconductive polymer layer, a graphite layer on the electroconductive polymer layer, and a silver layer on the graphite layer, including: forming a chemical bond between the electroconductive polymer layer and the graphite layer, and/or, a chemical bond between the graphite layer and the silver layer, by heating.

### Effect of the Invention

According to the present invention, a solid electrolytic capacitor having a low initial ESR in which the ESR increase with time can be suppressed can be provided.

### BRIEF DESCRIPTION OF DRAWING

FIG. 1 is a schematic cross-sectional view of one example of the solid electrolytic capacitor according to the present invention.

### MODE FOR CARRYING OUT THE INVENTION

The solid electrolytic capacitor according to the present invention is a solid electrolytic capacitor, including an electroconductive polymer layer, a graphite layer on the electroconductive polymer layer, and a silver layer on the graphite layer, wherein the electroconductive polymer layer and the graphite layer, and/or, the graphite layer and the silver layer are bonded by a chemical bond.

Since the solid electrolytic capacitor according to the present invention has a constitution in which the electroconductive polymer layer and the graphite layer, and/or, the graphite layer and the silver layer are strongly bonded by a chemical bond between the layers, the delamination of each layer is suppressed. Thereby, the increase of the interface resistance due to the delamination can be prevented, and the initial ESR is low, and also the ESR increase with time can be suppressed. Note that, “a layer and a layer are bonded by a chemical bond” means a condition that the materials composed of the layers are chemically bonded. For example, it means a condition that the bonding agents contained in the layers are chemically bonded. Also, the layers which are bonded by a chemical bond are directly contacted. Also, the chemical bond between the layer and the layer may be partly formed between the layer and the layer, or may be formed in whole.

In the present invention, if at least one of the electroconductive polymer layer and graphite layer, and the graphite layer and silver layer are chemically bonded at least in part between the layers, the effect of the present invention can sufficiently be realized. However, if the electroconductive polymer layer and graphite layer, and the graphite layer and silver layer are bonded by a chemical bond, a synergistic effect can be obtained and the increase of the interface resistance can further be prevented. Thereby, the initial ESR can be made lower, and also the ESR increase with time can further be suppressed. Note that, it can be confirmed by FT-IR that the electroconductive polymer layer and graphite layer, and/or, the graphite layer and silver layer are bonded by a chemical bond.

In the present invention, it is preferable that the electroconductive polymer layer and the graphite layer respectively contain additive A and additive B, and/or, wherein the graphite layer and the silver layer respectively contain additive B and additive C; and that the electroconductive polymer layer and the graphite layer, and/or, the graphite layer and the silver layer are respectively bonded by a chemical bond of additive A and additive B, and/or, by a chemical bond of additive B and additive C. Additive A, additive B, and additive C have a function as a bonding agent in each layer. It is more preferable that the electroconductive polymer layer, the graphite layer, and the silver layer respectively contain additive A, additive B, and additive C; and that the electroconductive polymer layer and the graphite layer, and the graphite layer and the silver layer are respectively bonded by a chemical bond of additive A and additive B and by a chemical bond of additive B and additive C.

The combination of additive A, additive B, and additive C can be appropriately selected from the combinations of the compounds having a functional group which can form a chemical bond when it is added to each layer.

In the present invention, preferably, additive B has at least one carboxyl group, and wherein additive A and/or additive C has at least one functional group selected from the group consisting of hydroxyl group, amino group, oxazoline group, and thiol group.

Also, preferably, additive B has at least one hydroxyl group, and wherein additive A and/or additive C has at least one functional group selected from the group consisting of carboxyl group, epoxy group, hydroxyl group, and isocyanate group.

Also, preferably, additive B has at least one thiol group, and wherein additive A and/or additive C has at least one functional group selected from the group consisting of epoxy group, carboxyl group, and isocyanate group.

Also, preferably, additive B has at least one amino group, and wherein additive A and/or additive C has at least one functional group selected from the group consisting of carboxyl group and epoxy group.

Also, preferably, additive B has at least one oxazoline group, and wherein additive A and/or additive C has at least one carboxyl group.

Also, preferably, additive B has at least one epoxy group, and wherein additive A and/or additive C has at least one functional group selected from the group consisting of hydroxyl group, thiol group, carboxyl group, and amino group.

Also, preferably, additive B has at least one isocyanate group, and wherein additive A and/or additive C has at least one functional group selected from the group consisting of hydroxyl group and thiol group.

From the standpoint of each bond strength between layers, the combination of the functional groups respectively in the additives is more preferably a combination of carboxyl group and hydroxyl group, carboxyl group and amino group, carboxyl group and oxazoline group, hydroxyl group and epoxy group, or amino group and epoxy group. By the combinations, an ester bond, an amide bond, a bond by amide and ester (—COOC₂H₄NHCO—), ether bond, and a bond by substitution of primary amine, secondary amine, or tertiary amine (—NHₙ—C—: n=0 or 1) are respectively formed between the layers.

Also, from the standpoint of smaller influence on the electroconductivity of the electroconductive polymer, the additive is more preferably an additive having a functional group selected from the group consisting of carboxyl group, hydroxyl group, oxazoline group, epoxy group, isocyanate group, and thiol group.

As follows, specific examples of each additive are shown, but each additive in the present invention is not limited to these. Also, each additive may have one kind of the functional groups shown below, or may have two or more kinds. Also, each additive may have one functional group, or may have two or more identical ones. When each additive has two or more functional groups in the molecule structure, since the bond between the layers becomes stronger, the initial ESR can further be decreased and the ESR increase with time can further be suppressed.

### [Additive Having a Carboxyl Group as the Functional Group]

Examples of the additive having a carboxyl group as the functional group include formic acid, acetic acid, propanoic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, henicosanoic acid, docosanoic acid, acrylic acid, oleic acid, linoleic acid, linolenic acid, arachidonic acid, docosahexaenoic acid, eicosapentaenoic acid, benzoic acid, salicylic acid, gallic acid, cinnamic acid, oxalic acid, acetylenedicarboxylic acid, malonic acid, succinic acid, fumaric acid, maleic acid, malic acid, oxaloacetic acid, glutaric acid, oxoglutaric acid, adipic acid, pimelic acid, suberic acid, azelaic acid, sebacic acid, citric acid, oxalosuccinic acid, ortho-phthalic acid, isophthalic acid, terephthalic acid, hemimellitic acid, trimesic acid, mellophanic acid, benzenepentacarboxylic acid, mellitic acid, and polyacrylic acids;

elastomers such as natural rubbers, 1,2-polybutadienes, butyl rubbers, ethylene-propylene rubbers, chlorosulfonated polyethylenes, acrylic rubbers, polysulfide rubbers, nitrile rubbers, isoprene rubbers, urethane rubbers, epichlorohydrin rubbers, chloroprene rubbers, silicone rubbers, styrene-butadiene rubbers, butadiene rubbers, fluorine rubbers, styrene-isoprene rubbers, styrene-ethylene-butylene rubbers, styrene-ethylene-propylene rubbers, polyesters, polyamides, and polyvinyl chlorides; elastomers which are cross-linked by vulcanization using these as a raw material; and polymer such as polyvinyls, polyethylenes, polypropylenes, polyesters, polystyrenes, polyurethanes, polyamides, polycarbonates, polyimides, and polyamide-imides; which have one or more carboxyl group; and
these derivatives. The polymer may be a homopolymer or may also be a copolymer. Also, in order to improve the chemical reactivity, the additive having a carboxyl group may be a derivative such as a carboxylic halide, a carboxylic anhydride, a carboxylic azide, and an active ester. This may be used alone or in combination with two or more kinds.

### [Additive Having a Hydroxyl Group as the Functional Group]

Examples of the additive having a hydroxyl group as the functional group include methanol, ethanol, propanol, butanol, pentanol, hexanol, heptanol, octanol, nonanol, decanol, undecanol, dodecanol, tridecanol, tetradecanol, pentadecanol, hexadecanol, heptadecanol, octadecanol, nonadecanol, icosanol, henicosanol, docosanol, ethylene glycol, butylene glycol, propylene glycol, pentanediol, 3-methyl-1,3-butanediol, hexylene glycol, hexanediol, heptanediol, octanediol, nonanediol, decanediol, undecanediol, dodecanediol, diethylene glycol, dipropylene glycol, glycerin, diglycerin, inositol, xylose, glucose, mannitol, trehalose, erythritol, xylitol, sorbitol, pentaerythritol, polyethylene glycols, polypropylene glycols, polyvinyl alcohols, and bisphenols such as bisphenol A;

elastomers such as natural rubbers, 1,2-polybutadienes, butyl rubbers, ethylene-propylene rubbers, chlorosulfonated polyethylenes, acrylic rubbers, polysulfide rubbers, nitrile rubbers, isoprene rubbers, urethane rubbers, epichlorohydrin rubbers, chloroprene rubbers, silicone rubbers, styrene-butadiene rubbers, butadiene rubbers, fluorine rubbers, styrene-isoprene rubbers, styrene-ethylene-butylene rubbers, styrene-ethylene-propylene rubbers, polyesters, polyamides, and polyvinyl chlorides; elastomers which are cross-linked by vulcanization using these as a raw material; and polymer such as polyvinyls, polyethylenes, polypropylenes, polyesters, polystyrenes, polyurethanes, polyamides, polycarbonates, polyimides, and polyamide-imides; which have one or more hydroxyl group; and these derivatives. The polymer may be a homopolymer or may also be a copolymer. This may be used alone or in combination with two or more kinds.

### [Additive Having an Amino Group as the Functional Group]

Examples of the additive having an amino group as the functional group include methylamine, ethylamine, propylamine, butylamine, pentylamine, hexylamine, heptylamine, octylamine, nonylamine, aminodecane, aminoundecane, aminododecane, aminotridecane, aminopentadecane, aminohexadecane, aminoheptadecane, aminooctadecane, aminononadecane, ethylenediamine, propanediamine, butanediamine, pentanediamine, hexanediamine, heptanediamine, octanediamine, nonanediamine, decanediamine, undecanediamine, and dodecanediamine; elastomers such as natural rubbers, 1,2-polybutadienes, butyl rubbers, ethylene-propylene rubbers, chlorosulfonated polyethylenes, acrylic rubbers, polysulfide rubbers, nitrile rubbers, isoprene rubbers, urethane rubbers, epichlorohydrin rubbers, chloroprene rubbers, silicone rubbers, styrene-butadiene rubbers, butadiene rubbers, fluorine rubbers, styrene-isoprene rubbers, styrene-ethylene-butylene rubbers, styrene-ethylene-propylene rubbers, polyesters, polyamides, and polyvinyl chlorides, which have one or more amino group; elastomers which are cross-linked by vulcanization using these as a raw material; and polymer such as polyvinyls, polyethylenes, polypropylenes, polyesters, polystyrenes, polyurethanes, polyamides, polycarbonates, polyimides, and polyamide-imides, which have one or more amino group; and

these derivatives. The polymer may be a homopolymer or may also be a copolymer. Also, the polymer is not limited to a primary amine, and it may also be a secondary amine or a tertiary amine. This may be used alone or in combination with two or more kinds.

### [Additive Having an Oxazoline Group as the Functional Group]

Examples of the additive having an oxazoline group as the functional group include 2-methyl-2-oxazoline, 2-ethyl-2-oxazoline, 2-propyl-2-oxazoline, 2-isopropyl-2-oxazoline, and 2-phenyl(2-oxazoline); elastomers such as natural rubbers, 1,2-polybutadienes, butyl rubbers, ethylene-propylene rubbers, chlorosulfonated polyethylenes, acrylic rubbers, polysulfide rubbers, nitrile rubbers, isoprene rubbers, urethane rubbers, epichlorohydrin rubbers, chloroprene rubbers, silicone rubbers, styrene-butadiene rubbers, butadiene rubbers, fluorine rubbers, styrene-isoprene rubbers, styrene-ethylene-butylene rubbers, styrene-ethylene-propylene rubbers, polyesters, polyamides, and polyvinyl chlorides, which have one or more oxazoline group; elastomers which are cross-linked by vulcanization using these as a raw material; and polymer such as polyvinyls, polyethylenes, polypropylenes, polyesters, polystyrenes, polyurethanes, polyamides, polycarbonates, polyimides, and polyamide-imides, which have one or more oxazoline group; and these derivatives. The polymer may be a homopolymer or may also be a copolymer. This may be used alone or in combination with two or more kinds.

### [Additive Having an Epoxy Group as the Functional Group]

Examples of the additive having an epoxy group as the functional group include allyl glycidyl ether, 2-ethylhexyl glycidyl ether, phenyl glycidyl ether, p-tert-butylphenyl glycidyl ether, N-glycidyl phthalimide, dibromophenyl glycidyl ether, 1,6-hexanediol diglycidyl ether, 1,4-butanediol diglycidyl ether, cyclohexanedimethanol diglycidyl ether, and diethylene glycol diglycidyl ether;

sorbitol polyglycidyl ether, polyglycerol polyglycidyl ether, diglycerol polyglycidyl ether, glycerol polyglycidyl ether, trimethylolpropane polyglycidyl ether, and polypropyleneglycol diglycidyl ether;
elastomers such as natural rubbers, 1,2-polybutadienes, butyl rubbers, ethylene-propylene rubbers, chlorosulfonated polyethylenes, acrylic rubbers, polysulfide rubbers, nitrile rubbers, isoprene rubbers, urethane rubbers, epichlorohydrin rubbers, chloroprene rubbers, silicone rubbers, styrene-butadiene rubbers, butadiene rubbers, fluorine rubbers, styrene-isoprene rubbers, styrene-ethylene-butylene rubbers, styrene-ethylene-propylene rubbers, polyesters, polyamides, and polyvinyl chlorides, which have one or more epoxy group; elastomers which are cross-linked by vulcanization using these as a raw material; and polymer such as polyvinyls, polyethylenes, polypropylenes, polyesters, polystyrenes, polyurethanes, polyamides, polycarbonates, polyimides, and polyamide-imides, which have one or more epoxy group; and
these derivatives. Note that, “polyglycidyl ether” means that Hs in at least two OH groups are substituted with epoxy group, and the upper limit of the number substituted with epoxy group is the number of OH group in the non-substituted compound. The polymer may be a homopolymer or may also be a copolymer. This may be used alone or in combination with two or more kinds.

### [Additive Having an Isocyanate Group as the Functional Group]

Examples of the additive having an isocyanate group as the functional group include 4,4′-diphenylmethane diisocyanate and polymethylene polyphenyl polyisocyanate;

elastomers such as natural rubbers, 1,2-polybutadienes, butyl rubbers, ethylene-propylene rubbers, chlorosulfonated polyethylenes, acrylic rubbers, polysulfide rubbers, nitrile rubbers, isoprene rubbers, urethane rubbers, epichlorohydrin rubbers, chloroprene rubbers, silicone rubbers, styrene-butadiene rubbers, butadiene rubbers, fluorine rubbers, styrene-isoprene rubbers, styrene-ethylene-butylene rubbers, styrene-ethylene-propylene rubbers, polyesters, polyamides, and polyvinyl chlorides; elastomers which are cross-linked by vulcanization using these as a raw material; and polymer such as polyvinyls, polyethylenes, polypropylenes, polyesters, polystyrenes, polyurethanes, polyamides, polycarbonates, polyimides, and polyamide-imides; which have one or more isocyanate group; and
these derivatives. The polymer may be a homopolymer or may also be a copolymer. This may be used alone or in combination with two or more kinds.

### [Additive Having a Thiol Group as the Functional Group]

Examples of the additive having a thiol group as the functional group include ethanethiol, propanethiol, 2-methyl-2-propanethiol, butanthiol, pentanethiol, hexanethiol, heptanethiol, octanethiol, nonanethiol, decanethiol, undecanethiol, dodecanthiol, tridecanethiol, tetradecanethiol, pentadecanethiol, hexadecanethiol, heptadecanethiol, octadecanethiol, ethanedithiol, propanedithiol, butanedithiol, pentanedithiol, hexanedithiol, heptanedithiol, octanedithiol, nonanedithiol, decanedithiol, undecanedithiol, dodecanedithiol, 3,6-dioxa-1,8-octanedithiol, 3,7-dithia-1,9-nonanedithiol benzenedithiol, naphthalenedithiol, 4,4′-biphenyldithiol, and toluenedithiol; elastomers such as natural rubbers, 1,2-polybutadienes, butyl rubbers, ethylene-propylene rubbers, chlorosulfonated polyethylenes, acrylic rubbers, polysulfide rubbers, nitrile rubbers, isoprene rubbers, urethane rubbers, epichlorohydrin rubbers, chloroprene rubbers, silicone rubbers, styrene-butadiene rubbers, butadiene rubbers, fluorine rubbers, styrene-isoprene rubbers, styrene-ethylene-butylene rubbers, styrene-ethylene-propylene rubbers, polyesters, polyamides, and polyvinyl chlorides, which have one or more thiol group; elastomers which are cross-linked by vulcanization using these as a raw material; and polymer such as polyvinyls, polyethylenes, polypropylenes, polyesters, polystyrenes, polyurethanes, polyamides, polycarbonates, polyimides, and polyimide-imides, which have one or more thiol group; and

these derivatives. The polymer may be a homopolymer or may also be a copolymer. This may be used alone or in combination with two or more kinds.

At least one selected from the group consisting of additive A, additive B, and additive C is preferably a polymer because the bond between the layers becomes stronger. The weight average molecular weight of the polymer is preferably 2000 or more and 1000000 or less. Note that, the weight average molecular weight of the polymer is a value measured by GPC (gel permeation chromatography) measurement. Also, in the present specification, examples of the polymer include elastomers (rubber-like polymers).

Examples of the electroconductive polymer contained in the electroconductive polymer layer include polymers which have thiophene, aniline, pyrrole, or a derivative thereof as a repeated unit. Specific examples of the thiophene derivative include 3,4-ethylenedioxythiophene or derivatives thereof, 3-alkylthiophenes such as 3-hexylthiophene, and 3-alkoxythiophenes such as 3-methoxythiophene. Specific examples of the aniline derivative include 2-alkylanilines such as 2-methyl aniline and 2-alkoxyanilines such as 2-methoxyaniline. Specific examples of the pyrrole derivative include 3-alkylpyrroles such as 3-hexylpyrrole, 3,4-dialkylpyrrole such as 3,4-dihexylpyrrole, 3-alkoxypyrrole such as 3-methoxypyrrole, and 3,4-dialkoxypyrrole such as 3,4-dimethoxypyrrole.

Among the monomers, 3,4-ethylenedioxythiophene or derivatives thereof are preferable. That is, the electroconductive polymer is preferably a poly(3,4-ethylenedioxythiophene) or a derivative thereof. Examples of the 3,4-ethylenedioxythiophene derivative include 3,4-(1-alkyl)ethylenedioxythiophene such as 3,4-(1-hexyl)ethylenedioxythiophene. The monomer may be used alone or in combination with two or more kinds. The electroconductive polymer may be a homopolymer or may also be a copolymer. The electroconductive polymer may be used alone or in combination with two or more kinds.

Examples of the dopant doped into the electroconductive polymer include alkylsulfonic acids, benzenesulfonic acid, naphthalenesulfonic acid, anthraquinonesulphonic acid, camphorsulfonic acid, polyacrylic acids, polystyrenesulfonic acids and derivatives thereof. This sulfonic acid may be a monosulfonic acid, a disulfonic acid, or a trisulfonic acid. Examples of the alkylsulfonic acid derivative include 2-acrylamide-2-methylpropanesulfonic acid. Examples of the benzenesulfonic acid derivative include phenolsulfonic acid, styrenesulfonic acid, toluenesulfonic acid, and dodecylbenzenesulfonic acid. Examples of the naphthalenesulfonic acid derivative include 1-naphthalenesulfonic acid, 2-naphthalenesulfonic acid, 1,3-naphthalenedisulfonic acid, 1,3,6-naphthalenetrisulfonic acid, and 6-ethyl-1-naphthalenesulfonic acid. Examples of the anthraquinonesulphonic acid derivative include anthraquinone-1-sulfonic acid, anthraquinone-2-sulfonic acid, anthraquinone-2,6-disulfonic acid, and 2-methylanthraquinone-6-sulfonic acid. Among these, the dopant is preferably a polystyrene sulfonic acid. This dopant may be used alone or in combination with two or more kinds.

The electroconductive polymer layer can be formed, for example, by an application or an impregnation of an electroconductive polymer suspension containing an electroconductive polymer in which a dopant is doped and by a drying. Examples of the solvent contained in the electroconductive polymer suspension include protic polar solvents such as water, methanol, ethanol, propanol, and acetic acid, and aprotic polar solvents such as N,N-dimethylformamide, dimethyl sulfoxide, acetonitrile, and acetone. This may be used alone or in combination with two or more kinds. In particular, it is preferable to use an electroconductive polymer suspension containing a poly(3,4-ethylenedioxythiophene) in which a polystyrene sulfonic acid is doped. Since the poly(3,4-ethylenedioxythiophene) in which a polystyrene sulfonic acid is doped is stably dispersed in water solvent, a suspension having high dispersibility can be obtained. Also, an electroconductive polymer composition obtained by removing the water solvent from the suspension has a high electroconductivity. Also, the electroconductive polymer suspension can contain a bonding agent. By dissolving or dispersing additive A as the bonding agent in the electroconductive polymer suspension, the electroconductive polymer layer obtained by an application or an impregnation of the electroconductive polymer suspension and by a drying can contain additive A. Another bonding agent which does not have reactivity with additive B may be added together with additive A. The drying temperature is, depending on the solvent used, preferably lower than 300° C. from the standpoint of preventing the deterioration of the electroconductive polymer by heat. Note that, for forming the electroconductive polymer layer, an electroconductive polymer solution in which the electroconductive polymer is completely dissolved can be used instead of the electroconductive polymer suspension.

The content of additive A in the electroconductive polymer layer is preferably 0.1 mass % or more and 50 mass % or less, is more preferably 1 mass % or more and 35 mass % or less, and is further preferably 2 mass % or more and 20 mass % or less. When the content is 0.1 mass % or more, the bond between the layers becomes strong by the reaction with additive B, and thereby the initial ESR is sufficiently decreased and the ESR increase with time can be suppressed. Also, when the content is 50 mass % or less, the effect of decreasing the initial ESR exceeds the influence of decreasing the electroconductivity due to the additive that is an insulating material, and thereby the initial ESR is sufficiently decreased. The thickness of the electroconductive polymer layer is not particularly limited but can be 1 μm or more and 100 μm or less.

Electroconductive polymer layer 3 may further contain an oxide derivative such as manganese dioxide and ruthenium oxide, and an organic semiconductor such as TCNQ (7,7,8,8-tetracyanoquinodimethane complex salt).

The graphite layer can be formed, for example, by using a graphite paste in which graphite or carbon black fine particles and a bonding agent is dispersed. By dissolving or dispersing additive B as the bonding agent in the graphite paste, the graphite layer obtained by an application or an impregnation of the graphite paste and by a drying can contain additive B. Another bonding agent which does not have reactivity with additive A and/or additive C may be added together with additive B. The drying temperature can be the same condition as that for forming the electroconductive polymer layer. The solvent is not particularly limited as long as it is a solvent in which graphite or carbon black fine particles and the bonding agent contained in the graphite paste can be dispersed or dissolved.

The content of additive B in the graphite layer is preferably 0.1 mass % or more and 50 mass % or less, is more preferably 1 mass % or more and 35 mass % or less, and is further preferably 2 mass % or more and 20 mass % or less. When the content is 0.1 mass % or more, the bond between the layers becomes strong by the reaction with additive A and/or additive C, and thereby the initial ESR is sufficiently decreased and the ESR increase with time can be suppressed. Also, when the content is 50 mass % or less, the effect of decreasing the initial ESR exceeds the influence of decreasing the electroconductivity due to the additive that is an insulating material, and thereby the initial ESR is sufficiently decreased. The thickness of the graphite layer is not particularly limited but can be 0.1 μm or more and 50 μm or less.

The silver layer can be formed, for example, by using a silver paste in which silver fine particles and a bonding agent is dispersed. By dissolving or dispersing additive C as the bonding agent in the silver paste, the silver layer obtained by an application or an impregnation of the silver paste and by a drying can contain additive C. Another bonding agent which does not have reactivity with additive B may be added together with additive C. The drying temperature can be the same condition as that for forming the electroconductive polymer layer. The solvent is not particularly limited as long as it is a solvent in which silver fine particles and the bonding agent contained in the silver paste can be dispersed or dissolved.

The content of additive C in the silver layer is preferably 0.1 mass % or more and 50 mass % or less, is more preferably 1 mass % or more and 35 mass % or less, and is further preferably 2 mass % or more and 20 mass % or less. When the content is 0.1 mass % or more, the bond between the layers becomes strong by the reaction with additive B, and thereby the initial ESR is sufficiently decreased and the ESR increase with time can be suppressed. Also, when the content is 50 mass % or less, the effect of decreasing the initial ESR exceeds the influence of decreasing the electroconductivity due to the additive that is an insulating material, and thereby the initial ESR is sufficiently decreased. The thickness of the silver layer is not particularly limited but can be 1 μm or more and 100 μm or less.

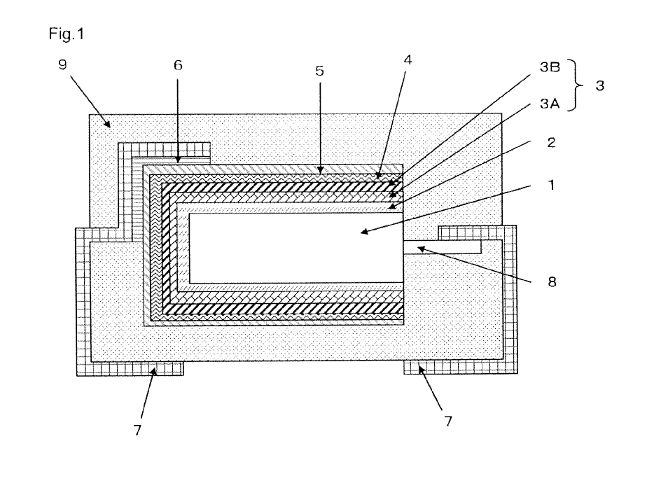

FIG. 1 is a schematic cross-sectional view of one example of the solid electrolytic capacitor according to the present invention. In the solid electrolytic capacitor, dielectric layer 2, electroconductive polymer layer 3, graphite layer 4, and silver layer 5 are formed on anode conductor 1 in this order. Electroconductive polymer layer 3 includes first electroconductive polymer layer 3A and second electroconductive polymer layer 3B. Anode conductor 1 has metal lead 8 and metal lead 8 is connected to electrode 7. Also, silver layer 5 is connected to another electrode 7 through electroconductive adhesive agent 6. The solid electrolytic capacitor is covered with packaging resin 9 in a condition where a part of two electrodes 7 was exposed outside.

Anode conductor 1 is formed of, for example; a plate, a foil, or a wire of a valve metal; a sintered body containing a valve metal fine particle; a porous body metal subjected to a surface area enlargement treatment by etching; or the like. Examples of the valve metal include tantalum, aluminum, titanium, niobium, zirconium, and alloys thereof. Among these, the valve metal is preferably at least one selected from the group consisting of aluminum, tantalum, and niobium.

Dielectric layer 2 can be formed by an electrolytic oxidation of the surface of anode conductor 1. In the case where anode conductor 1 is a sintered body or a porous body metal, dielectric layer 2 is also formed in the pores of the sintered body or the porous body metal. The thickness of dielectric layer 2 can be appropriately adjusted by the voltage of the electrolytic oxidation.

Electroconductive polymer layer 3 may have a single-layered conformation, but may also be a multi-layered conformation. In solid electrolytic capacitor shown in FIG. 1, electroconductive polymer layer 3 includes first electroconductive polymer layer 3A and second electroconductive polymer layer 3B. The first electroconductive polymer contained in first electroconductive polymer layer 3A and the second electroconductive polymer contained in second electroconductive polymer layer 3B may be a different type of electroconductive polymer, but they are preferably the same type of electroconductive polymer.

Examples of the method for forming electroconductive polymer layer 3 include, for example, a method by an application or an impregnation of the above-mentioned electroconductive polymer suspension on dielectric layer 2 and by a removal of the solvent. Also, electroconductive polymer layer 3 in the solid electrolytic capacitor shown in FIG. 1 can be formed, for example, by the following method. First electroconductive polymer layer 3A is formed on dielectric layer 2 by a chemical oxidation polymerization or an electropolymerization of a monomer providing a first electroconductive polymer. Second electroconductive polymer layer 3B is formed by an application or an impregnation of the above-mentioned electroconductive polymer suspension on first electroconductive polymer layer 3A.

As the monomer providing the first electroconductive polymer, at least one selected from the group consisting of pyrrole, thiophene, aniline, and derivatives thereof can be used. The dopant used for obtaining the first electroconductive polymer by a chemical oxidation polymerization or an electropolymerization of the monomer is preferably a sulfonic acid compound such as benzenesulfonic acid, naphthalenesulfonic acid, phenolsulfonic acid, styrenesulfonic acid, or a derivative thereof. The molecular weight of the dopant is not particularly limited, and it can appropriately be selected. The solvent may be water or a mixed solvent containing water and a water-soluble organic solvent.

The method of the application or the impregnation of the electroconductive polymer suspension is not particularly limited. However, in order to sufficiently fill the electroconductive polymer suspension into the porous pore inside, it is preferably left for several minutes to several ten minutes after the application or the impregnation of the electroconductive polymer suspension. Also, the immersion of the electroconductive polymer suspension is preferably repeated, and a reduced pressure system or a pressurized system is preferably adopted.

The removal of the solvent from the electroconductive polymer suspension can be carried out by drying. The drying temperature is not particularly limited as long as it is in a temperature range at which the solvent can be removed, but is preferably lower than 300° C. in order to prevent the deterioration of the electroconductive polymer by heat. The drying time may be appropriately selected by the drying temperature, but is not particularly limited as long as the electroconductivity of the electroconductive polymer is not damaged.

Examples of the method for forming the graphite layer include, for example, a method by an application or an impregnation of the above-mentioned graphite paste on electroconductive polymer layer 3 and by a removal of the solvent. The removal of the solvent from the graphite paste can be carried out by drying. The drying temperature is not particularly limited as long as it is in a temperature range at which the solvent can be removed, but is preferably lower than 300° C. in order to prevent the deterioration of the electroconductive polymer by heat. The drying time may be appropriately selected by the drying temperature, but is not particularly limited as long as the electroconductivity of the electroconductive polymer is not damaged.

Examples of the method for forming the silver layer include, for example, a method by an application or an impregnation of the above-mentioned silver paste on graphite layer 4 and by a removal of the solvent. The removal of the solvent from the silver paste can be carried out by drying. The drying temperature is not particularly limited as long as it is in a temperature range at which the solvent can be removed, but is preferably lower than 300° C. in order to prevent the deterioration of the electroconductive polymer by heat. The drying time may be appropriately selected by the drying temperature, but is not particularly limited as long as the electroconductivity of the electroconductive polymer is not damaged.

In the present invention, additive A and additive B, and/or, additive B and additive C are chemically reacted by heating as at the time of drying or the like, to bond the electroconductive polymer layer and the graphite layer, and/or, the graphite layer and the silver layer by a chemical bond. The heating for forming the chemical bond may be carried out together with the drying for forming the graphite layer, and/or, the silver layer, or it may separately be carried out after forming all layers. The heating temperature for forming the chemical bond is preferably lower than 300° C. from the standpoint of preventing the deterioration of the electroconductive polymer by heat, and is more preferably 50° C. or higher and 250° C. or lower.

Note that, in order to promote the chemical reaction of the additives, each layer of the electroconductive polymer layer, the graphite layer, and the silver layer may further contain a catalyst.

The method for producing a solid electrolytic capacitor according to the present invention is a method for producing a solid electrolytic capacitor which includes an electroconductive polymer layer, a graphite layer on the electroconductive polymer layer, and a silver layer on the graphite layer, in which it has a step for forming a chemical bond between the electroconductive polymer layer and the graphite layer, and/or, a chemical bond between the graphite layer and the silver layer, by heating. The heating condition can be adopted from the above-mentioned conditions. By the method, a solid electrolytic capacitor having a chemical bond at least in part between the layers can be obtained.

### EXAMPLES

### Example 1

In this Example, a solid electrolytic capacitor shown in FIG. 1 was produced by the following method.

A tantalum fine particle sintered body (valve metal porous body) as anode conductor 1 was anodized at 10 V in a phosphoric acid aqueous solution to obtain a pellet in which the whole surface of the tantalum fine particle sintered body was coated with dielectric layer 2. Then, the pellet was immersed in an electroconductive polymer suspension containing a poly(3,4-ethylenedioxythiophene) as the electroconductive polymer in which a polystyrene sulfonic acid was doped, a mixed solvent as a solvent containing 5 mass % of dimethyl sulfoxide that was an aprotic solvent and 95 mass % of water, and pentaerythritol having a hydroxyl group as additive A, and it was pulled up. After that, this was dried at 120° C. for 1 hour to form electroconductive polymer layer 3 on dielectric layer 2. The content of additive A in electroconductive polymer layer 3 was 10 mass %. The thickness of electroconductive polymer layer 3 was 10 to 20 μm.

After the formation of electroconductive polymer layer 3, the pellet was immersed in a graphite paste containing graphite fine particles, N,N-dimethylformamide as the solvent, and terephthalic acid having carboxyl group as additive B, and it was pulled up. After that, this was dried at 120° C. for 1 hour to form graphite layer 4 on electroconductive polymer layer 3. The content of additive B in graphite layer 4 was 10 mass %. The thickness of graphite layer 4 was 5 to 10 μm.

After the formation of graphite layer 4, the pellet was immersed in a silver paste containing silver fine particles, propylene glycol monomethyl ether acetate as the solvent, and it was pulled up. After that, this was dried at 120° C. for 1 hour to form silver layer 5 on graphite layer 4. The thickness of silver layer 5 was 20 to 30 μm.

After the formation of silver layer 5, in order to form a chemical bond between electroconductive polymer layer 3 and graphite layer 4, it was further heated at 150° C. for 1 hour. Thereby, additive A contained in electroconductive polymer layer 3 and additive B contained in graphite layer 4 were chemically bonded.

Subsequently, electroconductive adhesive agent 6, electrode 7, and packaging resin 9 which were shown in FIG. 1 were formed in this order to produce a solid electrolytic capacitor. Note that, in the solid electrolytic capacitor obtained, it was confirmed by FT-IR (product name: Spectrum One/AutoIMAGE, made by PerkinElmer) that an ester bond was formed between electroconductive polymer layer 3 and graphite layer 4.

The initial ESR of the solid electrolytic capacitor produced was measured at a frequency of 100 kHz. Also, the ESRs after heat resistance reliability of 1000 hours at 125° C. and after humidity resistance test of 1000 hours at 65° C./95% RH were measured in the same manner. The measurement results were standardized from the total area of the cathode portion to a unit area (1 cm²). The results are shown in TABLE 1.

### Examples 2 to 46

Solid electrolytic capacitors were produced in the same manner as in Example 1 except that additive A, additive B, and additive C shown in TABLES 1 to 3 were used. Note that, additive C was used by adding it to a silver paste. In all examples, the content of additive C in silver layer 5 was 10 mass %. Also, each ESR was measured in the same manner as in Example 1. The results are shown in TABLES 1 to 3. Note that, in all solid electrolytic capacitors obtained, it was confirmed by FT-IR that a chemical bond between electroconductive polymer layer 3 and graphite layer 4, and/or, a chemical bond between graphite layer 4 and silver layer 5 was formed.

### Example 47

A solid electrolytic capacitor was produced in the same manner as in Example 45 except that the contents of additive A, additive B, and additive C were each set to be 0.1 mass %. Also, each ESR was measured in the same manner as in Example 1. The results are shown in TABLE 3. Note that, in the solid electrolytic capacitor obtained, it was confirmed by FT-IR that ester bonds between electroconductive polymer layer 3 and graphite layer 4 and between graphite layer 4 and silver layer 5 were formed.

### Example 48

A solid electrolytic capacitor was produced in the same manner as in Example 45 except that the contents of additive A, additive B, and additive C were each set to be 1 mass %. Also, each ESR was measured in the same manner as in Example 1. The results are shown in TABLE 3. Note that, in the solid electrolytic capacitor obtained, it was confirmed by FT-IR that ester bonds between electroconductive polymer layer 3 and graphite layer 4 and between graphite layer 4 and silver layer 5 were formed.

### Example 49

A solid electrolytic capacitor was produced in the same manner as in Example 45 except that the contents of additive A, additive B, and additive C were each set to be 20 mass %. Also, each ESR was measured in the same manner as in Example 1. The results are shown in TABLE 3. Note that, in the solid electrolytic capacitor obtained, it was confirmed by FT-IR that ester bonds between electroconductive polymer layer 3 and graphite layer 4 and between graphite layer 4 and silver layer 5 were formed.

### Example 50

A solid electrolytic capacitor was produced in the same manner as in Example 45 except that the contents of additive A, additive B, and additive C were each set to be 50 mass %. Also, each ESR was measured in the same manner as in Example 1. The results are shown in TABLE 3. Note that, in the solid electrolytic capacitor obtained, it was confirmed by FT-IR that ester bonds between electroconductive polymer layer 3 and graphite layer 4 and between graphite layer 4 and silver layer 5 were formed.

### Example 51

A solid electrolytic capacitor was produced in the same manner as in Example 1 except that an electroconductive polymer suspension containing a self-doping type polyaniline having a sulfo group in the molecule as the electroconductive polymer, water as the solvent, and pentaerythritol as additive A was used. Also, each ESR was measured in the same manner as in Example 1. The results are shown in TABLE 3. Note that, in the solid electrolytic capacitor obtained, it was confirmed by FT-IR that an ester bond between electroconductive polymer layer 3 and graphite layer 4 was formed.

### Comparative Example 1

A solid electrolytic capacitor was produced in the same manner as in Example 1 except that any of additive A, additive B, and additive C was not added. Also, each ESR was measured in the same manner as in Example 1. The results are shown in TABLE 3. Note that, in the solid electrolytic capacitor obtained, it was confirmed by FT-IR that chemical bonds between electroconductive polymer layer 3 and graphite layer 4 and between graphite layer 4 and silver layer 5 were not formed.

TABLE 1

| | | | | | ESR after | ESR after |
|---|---|---|---|---|---|---|
| | additive A | additive B | additive C | initial | 1000 h at | 1000 h at |
| | (functional | (functional | (functional | ESR | 125° C. | 65° C./95% RH |
| | group therein) | group therein) | group therein) | [mΩ · cm²] | [mΩ · cm²] | [mΩ · cm²] |
| Ex. 1 | pentaerythritol | terephthalic acid | — | 2.6 | 4.2 | 3.7 |
| | (hydroxyl group) | (carboxyl group) | | | | |
| Ex. 2 | octylamine | maleic anhydride | — | 3.3 | 5.1 | 4.6 |
| | (amino group) | (carboxyl group) | | | | |
| Ex. 3 | 2-isopropyl-2-oxazoline | octadecanoic acid | — | 2.8 | 4.5 | 3.8 |
| | (oxazoline group) | (carboxyl group) | | | | |
| Ex. 4 | butanedithiol | oleic acid | — | 3.0 | 4.8 | 4.2 |
| | (thiol group) | (carboxyl group) | | | | |
| Ex. 5 | ortho-phthalic acid | sorbitol | — | 2.7 | 4.3 | 3.8 |
| | (carboxyl group) | (hydroxyl group) | | | | |
| Ex. 6 | diethyleneglycol | docosanol | — | 2.7 | 4.2 | 3.7 |
| | diglycidyl ether | (hydroxyl group) | | | | |
| | (epoxy group) | | | | | |
| Ex. 7 | polyethylene glycol | propanol | — | 2.9 | 4.6 | 4.1 |
| | (hydroxyl group) | (hydroxyl group) | | | | |
| Ex. 8 | 4,4′-diphenylmethane | dodecanol | — | 3.2 | 5.1 | 4.7 |
| | diisocyanate | (hydroxyl group) | | | | |
| | (isocyanate group) | | | | | |
| Ex. 9 | phenyl glycidyl ether | 4,4′-biphenyldithiol | — | 3.1 | 4.9 | 4.3 |
| | (epoxy group) | (thiol group) | | | | |
| Ex. 10 | propanoic acid | 2-methyl-2-propanethiol | — | 3.1 | 5.0 | 4.4 |
| | (carboxyl group) | (thiol group) | | | | |
| Ex. 11 | polymethylene polyphenyl | octadecanethiol | — | 3.3 | 5.3 | 4.8 |
| | polyisocyanate | (thiol group) | | | | |
| | (isocyanate group) | | | | | |
| Ex. 12 | polyacrylic acid | aminodecane | — | 3.0 | 4.9 | 4.3 |
| | (carboxyl group) | (amino group) | | | | |
| Ex. 13 | allyl glycidyl ether | pentanediamine | — | 3.1 | 5.0 | 4.3 |
| | (epoxy group) | (amino group) | | | | |
| Ex. 14 | adipic acid | 2-phenyl(2-oxazoline) | — | 2.8 | 4.5 | 3.9 |
| | (carboxyl group) | (oxazoline group) | | | | |
| Ex. 15 | ethylene glycol | cyclohexanedimethanol | — | 2.7 | 4.3 | 3.8 |
| | (hydroxyl group) | diglycidyl ether | | | | |
| | | (epoxy group) | | | | |
| Ex. 16 | naphthalenedithiol | 2-ethylhexyl glycidyl ether | — | 2.9 | 4.7 | 4.0 |
| | (thiol group) | (epoxy group) | | | | |

TABLE 2

| | | | | | ESR after | ESR after |
|---|---|---|---|---|---|---|
| | additive A | additive B | additive C | initial | 1000 h at | 1000 h at |
| | (functional | (functional | (functional | ESR | 125° C. | 65° C./95% RH |
| | group therein) | group therein) | group therein) | [mΩ · cm²] | [mΩ · cm²] | [mΩ · cm²] |
| Ex. 17 | citric acid | 1,4-butanediol | — | 2.8 | 4.4 | 4.0 |
| | (carboxyl group) | diglycidyl ether | | | | |
| | | (epoxy group) | | | | |
| Ex. 18 | butylamine | sorbitol polyglycidyl ether | — | 3.3 | 5.2 | 4.5 |
| | (amino group) | (epoxy group) | | | | |
| Ex. 19 | erythritol | polymethylene polyphenyl | — | 3.1 | 4.9 | 4.4 |
| | (hydroxyl group) | polyisocyanate | | | | |
| | | (isocyanate group) | | | | |
| Ex. 20 | pentanethiol | 4,4′-diphenylmethane | — | 3.2 | 5.0 | 4.6 |
| | (thiol group) | diisocyanate | | | | |
| | | (isocyanate group) | | | | |
| Ex. 21 | oxazolinated polyvinyl | carboxylated polyethylene | — | 2.4 | 3.7 | 3.1 |
| | (oxazoline group) | (carboxyl group) | | | | |
| Ex. 22 | carboxylated isoprene | hydroxylated acryl | — | 2.5 | 3.9 | 3.3 |
| | rubber [elastomer] | rubber [elastomer] | | | | |
| | (carboxyl group) | (hydroxyl group) | | | | |
| Ex. 23 | — | oleic acid | diethyleneglycol | 2.8 | 4.5 | 3.9 |
| | | (carboxyl group) | (hydroxyl group) | | | |
| Ex. 24 | — | benzoic acid | decanediamine | 3.0 | 4.8 | 4.2 |
| | | (carboxyl group) | (amino group) | | | |
| Ex. 25 | — | nonadecanoic acid | 2-propyl-2-oxazoline | 2.8 | 4.6 | 3.9 |
| | | (carboxyl group) | (oxazoline group) | | | |
| Ex. 26 | — | decanoic acid | tridecanethiol | 3.2 | 5.1 | 4.6 |
| | | (carboxyl group) | (thiol group) | | | |
| Ex. 27 | — | mannitol | hexanoic acid | 2.8 | 4.5 | 4.0 |
| | | (hydroxyl group) | (carboxyl group) | | | |
| Ex. 28 | — | polypropylene glycol | diglycerol | 2.7 | 4.3 | 3.8 |
| | | (hydroxyl group) | polyglycidyl ether | | | |
| | | | (epoxy group) | | | |
| Ex. 29 | — | octadecanol | 3-methyl-1,3-butanediol | 3.1 | 5.0 | 4.3 |
| | | (hydroxyl group) | (hydroxyl group) | | | |
| Ex. 30 | — | diglycerin | 4,4′-diphenylmethane | 2.9 | 4.6 | 4.3 |
| | | (hydroxyl group) | diisocyanate | | | |
| | | | (isocyanate group) | | | |
| Ex. 31 | — | octanethiol | N-glycidyl phthalimide | 3.0 | 4.8 | 4.2 |
| | | (thiol group) | (epoxy group) | | | |
| Ex. 32 | — | hexanedithiol | glutaric acid | 3.0 | 5.0 | 4.2 |
| | | (thiol group) | (carboxyl group) | | | |

TABLE 3

| | | | | | ESR after | ESR after |
|---|---|---|---|---|---|---|
| | additive A | additive B | additive C | initial | 1000 h at | 1000 h at |
| | (functional | (functional | (functional | ESR | 125° C. | 65° C./95% RH |
| | group therein) | group therein) | group therein) | [mΩ · cm²] | [mΩ · cm²] | [mΩ · cm²] |
| Ex. 33 | — | dodecanedithiol | polymethylene polyphenyl | 3.2 | 5.1 | 4.7 |
| | | (thiol group) | polyisocyanate | | | |
| | | | (isocyanate group) | | | |
| Ex. 34 | — | aminooctadecane | azelaic acid | 3.3 | 5.3 | 4.6 |
| | | (amino group) | (carboxyl group) | | | |
| Ex. 35 | — | hexylamine | 1,6-hexanediol | 3.2 | 5.0 | 4.5 |
| | | (amino group) | diglycidyl ether | | | |
| | | | (epoxy group) | | | |
| Ex. 36 | — | 2-ethyl-2-oxazoline | isophthalic acid | 2.9 | 4.7 | 4.0 |
| | | (oxazoline group) | (carboxyl group) | | | |
| Ex. 37 | — | p-tert-butylphenyl | dodecanediol | 2.8 | 4.4 | 3.8 |
| | | glycidyl ether | (hydroxyl group) | | | |
| | | (epoxy group) | | | | |
| Ex. 38 | — | polypropyleneglycol | 3,6-dioxa-1,8-octanedithiol | 3.0 | 4.9 | 4.4 |
| | | diglycidyl ether | (thiol group) | | | |
| | | (epoxy group) | | | | |
| Ex. 39 | — | glycerol | acetylenedicarboxylic acid | 2.8 | 4.5 | 3.9 |
| | | polyglycidyl ether | (carboxyl group) | | | |
| | | (epoxy group) | | | | |
| Ex. 40 | — | trimethylolpropane | octanediamine | 3.1 | 4.9 | 4.3 |
| | | polyglycidyl ether | (amino group) | | | |
| | | (epoxy group) | | | | |
| Ex. 41 | — | polymethylene polyphenyl | dipropylene glycol | 3.0 | 4.8 | 4.5 |
| | | polyisocyanate | (hydroxyl group) | | | |
| | | (isocyanate group) | | | | |
| Ex. 42 | — | 4,4′-diphenylmethane | 3,7-dithia-1,9-nonanedithiol | 3.2 | 5.2 | 4.6 |
| | | diisocyanate | benzenedithiol | | | |
| | | (isocyanate group) | (thiol group) | | | |
| Ex. 43 | — | carboxylated polyester | epoxydated polyester | 2.6 | 4.0 | 3.4 |
| | | (carboxyl group) | (epoxy group) | | | |
| Ex. 44 | — | epoxydated styrene- | hydroxylated | 2.7 | 4.2 | 3.5 |
| | | butadiene rubber [elastomer] | butadiene rubber [elastomer] | | | |
| | | (epoxy group) | (hydroxyl group) | | | |
| Ex. 45 | xylitol | hemimellitic acid | bisphenol-A | 2.2 | 3.2 | 2.8 |
| | (hydroxyl group) | (carboxyl group) | (hydroxyl group) | | | |
| Ex. 46 | carboxylated polyester | polyvinyl alcohol | epoxydated fluorine | 2.0 | 2.8 | 2.4 |
| | (carboxyl group) | (hydroxyl group) | rubber [elastomer] | | | |
| | | | (epoxy group) | | | |
| Ex. 47 | xylitol | hemimellitic acid | bisphenol-A | 3.5 | 6.2 | 5.1 |
| | (hydroxyl group) | (carboxyl group) | (hydroxyl group) | | | |
| Ex. 48 | xylitol | hemimellitic acid | bisphenol-A | 3.4 | 5.8 | 4.8 |
| | (hydroxyl group) | (carboxyl group) | (hydroxyl group) | | | |
| Ex. 49 | xylitol | hemimellitic acid | bisphenol-A | 2.5 | 3.7 | 3.1 |
| | (hydroxyl group) | (carboxyl group) | (hydroxyl group) | | | |
| Ex. 50 | xylitol | hemimellitic acid | bisphenol-A | 3.5 | 5.6 | 4.9 |
| | (hydroxyl group) | (carboxyl group) | (hydroxyl group) | | | |
| Ex. 51 | pentaerythritol | terephthalic acid | — | 3.4 | 5.5 | 5.0 |
| | (hydroxyl group) | (carboxyl group) | | | | |
| Comp. | — | — | — | 3.6 | 6.5 | 5.4 |
| Ex. 1 | | | | | | |

### REFERENCE SIGNS LIST

1 anode conductor
2 dielectric layer
3 electroconductive polymer layer
3A first electroconductive polymer layer
3B second electroconductive polymer layer
4 graphite layer
5 silver layer
6 electroconductive adhesive agent
7 electrode
8 metal lead
9 packaging resin

What is claimed is:

1. A solid electrolytic capacitor, comprising an electroconductive polymer layer, a graphite layer on the electroconductive polymer layer, and a silver layer on the graphite layer,
wherein the electroconductive polymer layer and the graphite layer, and/or, the graphite layer and the silver layer are bonded by a chemical bond.

2. The solid electrolytic capacitor according to claim 1,
wherein the electroconductive polymer layer and the graphite layer respectively comprises additive A and additive B, and/or, wherein the graphite layer and the silver layer respectively comprises additive B and additive C; and
wherein the electroconductive polymer layer and the graphite layer, and/or, the graphite layer and the silver layer are respectively bonded by a chemical bond of additive A and additive B, and/or, by a chemical bond of additive B and additive C.

3. The solid electrolytic capacitor according to claim 2, wherein additive B has at least one carboxyl group, and wherein additive A and/or additive C has at least one functional group selected from the group consisting of hydroxyl group, amino group, oxazoline group, and thiol group.

4. The solid electrolytic capacitor according to claim 2, wherein additive B has at least one hydroxyl group, and wherein additive A and/or additive C has at least one functional group selected from the group consisting of carboxyl group, epoxy group, hydroxyl group, and isocyanate group.

5. The solid electrolytic capacitor according to claim 2, wherein additive B has at least one thiol group, and wherein additive A and/or additive C has at least one functional group selected from the group consisting of epoxy group, carboxyl group, and isocyanate group.

6. The solid electrolytic capacitor according to claim 2, wherein additive B has at least one amino group, and wherein additive A and/or additive C has at least one functional group selected from the group consisting of carboxyl group and epoxy group.

7. The solid electrolytic capacitor according to claim 2, wherein additive B has at least one oxazoline group, and wherein additive A and/or additive C has at least one carboxyl group.

8. The solid electrolytic capacitor according to claim 2, wherein additive B has at least one epoxy group, and wherein additive A and/or additive C has at least one functional group selected from the group consisting of hydroxyl group, thiol group, carboxyl group, and amino group.

9. The solid electrolytic capacitor according to claim 2, wherein additive B has at least one isocyanate group, and wherein additive A and/or additive C has at least one functional group selected from the group consisting of hydroxyl group and thiol group.

10. The solid electrolytic capacitor according to claim 2, wherein at least one selected from the group consisting of additive A, additive B, and additive C is a polymer.

11. The solid electrolytic capacitor according to claim 1, wherein the electroconductive polymer layer, the graphite layer, and the silver layer respectively comprises additive A, additive B, and additive C, and wherein the electroconductive polymer layer and the graphite layer are bonded by a chemical bond of additive A and additive B, and wherein the graphite layer and the silver layer are bonded by a chemical bond of additive B and additive C.

12. A method for producing a solid electrolytic capacitor which comprises an electroconductive polymer layer, a graphite layer on the electroconductive polymer layer, and a silver layer on the graphite layer, comprising:
forming a chemical bond between the electroconductive polymer layer and the graphite layer, and/or, a chemical bond between the graphite layer and the silver layer, by heating.
